(19) United States
(12) Patent Application Publication
(10) Pub. No.: US 2014/0229655 A1
(43) Pub. Date: Aug. 14, 2014

(54) Storing Error Correction Code (ECC) Data In a Multi-Tier Memory Structure

(71) Applicant: SEAGATE TECHNOLOGY LLC, Cupertino, CA (US)

(72) Inventors: Ryan James Goss, Prior Lake, MN (US); Mark Allen Gaertner, Vadnais Heights, MN (US); Ara Patapoutian, Hopkinton, MA (US)

(73) Assignee: SEAGATE TECHNOLOGY LLC, Cupertino, CA (US)

(21) Appl. No.: 13/762,765

(22) Filed: Feb. 8, 2013

(51) Int. Cl. G06F 12/02

(52) U.S. Cl. CPC G06F 12/0246
USPC 711/103

(57) ABSTRACT

Method and apparatus for managing data in a memory. In accordance with some embodiments, a data object is stored in a first non-volatile tier of a multi-tier memory structure. An ECC data set adapted to detect at least one bit error in the data object during a read operation is generated. The ECC data set is stored in a different, second non-volatile tier of the multi-tier memory structure.

### SUMMARY

Various embodiments of the present disclosure are generally directed to managing data in a memory.

In accordance with some embodiments, a data object is stored in a first non-volatile tier of a multi-tier memory structure. An ECC data set adapted to detect at least one bit error in the data object during a read operation is generated. The ECC data set is stored in a different, second non-volatile tier of the multi-tier memory structure.

These and other features and aspects which characterize various embodiments of the present disclosure can be understood in view of the following detailed discussion and the accompanying drawings.

### BRIEF DESCRIPTION OF THE DRAWINGS

FIG. 1 provides is a functional block representation of a data storage device having a multi-tier memory structure in accordance with various embodiments of the present disclosure.

FIG. 2 is a schematic representation of an erasable memory useful in the multi-tier memory structure of FIG. 1.

FIG. 3 provides a schematic representation of a rewritable memory useful in the multi-tier memory structure of FIG. 1.

FIG. 4 shows an arrangement of a selected memory tier from FIG. 1.

FIG. 5 illustrates exemplary formats for data objects, ECC data and metadata units used by the device of FIG. 1.

FIG. 6 is a functional block representation of portions of the device of FIG. 1 in accordance with some embodiments.

FIG. 7 depicts aspects of the data object engine of FIG. 6 in greater detail.

FIG. 8 represents aspects of the ECC engine of FIG. 6 in greater detail.

FIG. 9 shows aspects of the metadata engine of FIG. 6 in greater detail.

FIG. 10 illustrates storage of a selected data object in an upper memory tier and storage of corresponding ECC data for the data object in a lower memory tier.

FIG. 11 depicts storage of ECC data in a higher tier and storage of a corresponding data object in a lower tier in accordance with some embodiments.

FIG. 11 depicts storage of a data object in a higher tier and storage of a corresponding ECC data set in a lower tier in accordance with other embodiments.

FIG. 12 provides steps carried out during a data write operation in accordance with some embodiments.

FIG. 13 illustrates steps carried out during a subsequent data read operation in accordance with some embodiments.

FIG. 14 depicts an operational life cycle of garbage collection units (GCUs) useful in accordance with various embodiments.

FIG. 15 shows steps carried out during a garbage collection operation in accordance with some embodiments.

### DETAILED DESCRIPTION

The present disclosure generally relates to the management of data in a multi-tier memory structure.

Data storage devices generally operate to store blocks of data in memory. The devices can employ data management systems to track the physical locations of the blocks so that the blocks can be subsequently retrieved responsive to a read request for the stored data. The device may be provided with a hierarchical (multi-tiered) memory structure with different types of memory at different levels, or tiers. The tiers are arranged in a selected priority order to accommodate data having different attributes and workload capabilities.

The various memory tiers may be erasable or rewriteable. Erasable memories (e.g, flash memory, write many optical disc media, etc.) are made up of erasable non-volatile memory cells that generally require an erasure operation before new data can be written to a given memory location. It is thus common in an erasable memory to write an updated data set to a new, different location and to mark the previously stored version of the data as stale.

Rewriteable memories (e.g., dynamic random access memory (DRAM), resistive random access memory (RRAM), magnetic disc media, etc.) may be volatile or non-volatile, and are formed from rewriteable non-volatile memory cells so that an updated data set can be overwritten onto an existing, older version of the data in a given location without the need for an intervening erasure operation.

Different types of control information, such as error correction code (ECC) data and metadata, can be stored in a memory structure to assist in the writing and subsequent reading hack of user data. ECC data allow facilitate the detection and/or correction of up to selected numbers of bit errors in a copy of a data object read back from memory. Metadata units track the relationship between logical elements (such as logical block addresses, LBAs) stored in the memory space and physical locations (such as physical block addresses, PBAs) of the memory space. The metadata can also include state information associated with the stored user data and the associated memory location, such as the total number of accumulated writes/erasures/reads, aging, drift parametrics, estimated or measured wear, etc.

Various embodiments of the present disclosure provide an improved approach to managing data in a multi-tiered memory structure. As explained below, data objects are formed from one or more user data blocks (e.g., LBAs) and stored in a selected tier in a multi-tier memory structure. An ECC data set is generated for each data object, and stored in a different tier, such as a lower tier or a higher tier than the tier used to store the data object. The size and configuration of the ECC data may be selected in relation to data attributes associated with the corresponding data object and in relation to memory attributes of the selected tier in which the ECC data are stored. Metadata may further be generated to track the locations of the data object and the ECC data, and the metadata may be stored in in a third tier different from the tiers used to respectively store the data object and the ECC data.

In this way, data objects having particular storage specific attributes can be paired or grouped and stored in a suitable memory tier that matches these attributes. The ECC data can be generated and stored in a suitable memory tier that matches the attributes of the ECC data and expected or observed workload associated with the data object.

These and other features of various embodiments disclosed herein can be understood beginning with a review of FIG. 1 which provides a functional block representation of a data storage device 100. The device 100 includes a controller 102 and a multi-tiered memory structure 104. The controller 102 provides top level control of the device 100, and the memory structure 104 stores and retrieves user data from/to a requestor entity, such as an external host device (not separately shown).

The memory structure 104 includes a number of memory tiers 106, 108 and 110 denoted as MEM 1-3. The number and types of memory in the various tiers can vary as desired. Generally, a priority order will be provided such that the higher tiers in the memory structure 104 may be constructed of smaller and/or faster memory and the lower tiers in the memory structure may be constructed of larger and/or slower memory. Other characteristics may determine the priority ordering of the tiers.

For purposes of providing one concrete example, the system 100 is contemplated as a flash memory-based storage device, such as a solid state drive (SSD), a portable thumb drive, a memory stick, a memory card, a hybrid storage device, etc. so that at least one of the lower memory tiers provides a main store that utilizes erasable flash memory. At least one of the higher memory tiers provides rewriteable non-volatile memory such as resistive random access memory (RRAM), phase change random access memory (PCRAM), spin-torque transfer random access memory (STRAM), etc. This is merely illustrative and not limiting. Other levels may be incorporated into the memory structure, such as volatile or non-volatile cache levels, buffers, etc.

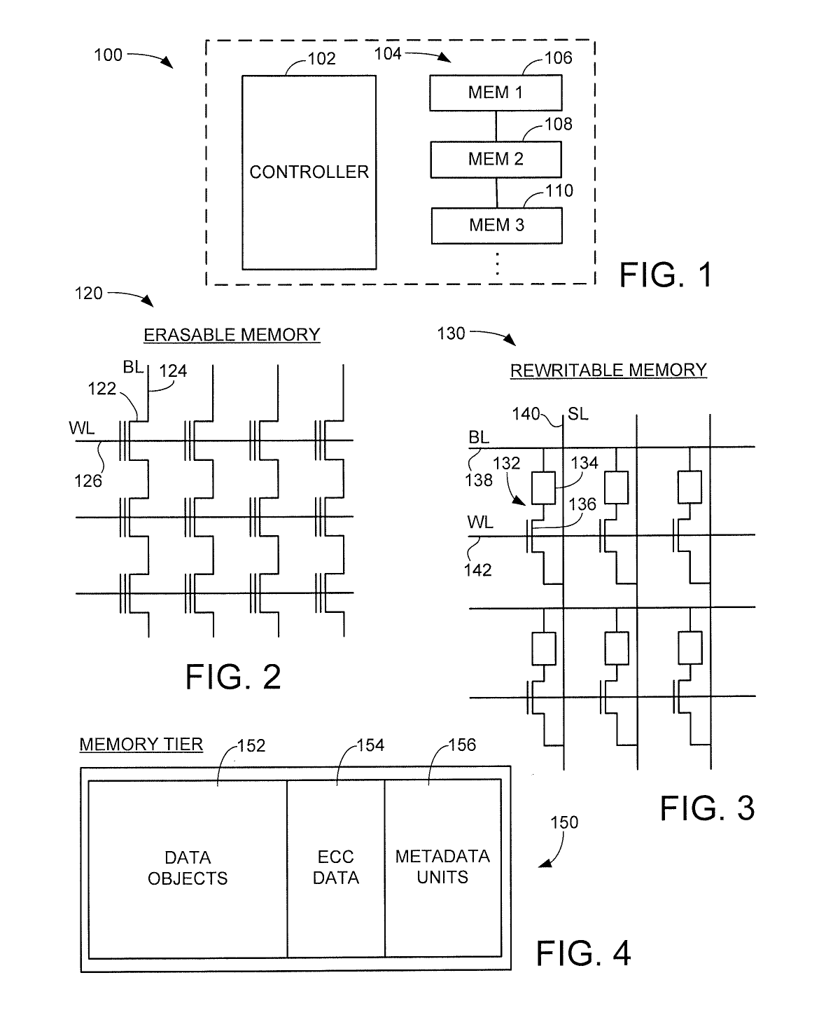

FIG. 2 illustrates an erasable memory 120 made up of an array of erasable memory cells 122, which in this case are characterized without limitation as flash memory cells. The erasable memory 120 can be utilized as one or more of the various memory tiers of the memory structure 104 in FIG. 1. In the case of flash memory cells, the cells 122 generally take the form of programmable elements having a generally nMOSFET (n-channel metal oxide semiconductor field effect transistor) configuration with a floating gate adapted to store accumulated charge. The programmed state of each flash memory cell 122 can be established in relation to the amount of voltage that needs to be applied to a control gate of the cell 122 to place the cell in a source-drain conductive state.

The memory cells 122 in FIG. 2 are arranged into a number of rows and columns, with each of the columns of cells 122 connected to a bit line (BL) 124 and each of the rows of cells 122 connected to a separate word line (WL) 126. Data may be stored along each row of cells as a page of data, which may represent a selected unit of memory storage (such as 8192 bits).

As noted above, erasable memory cells such as the flash memory cells 122 can be adapted to store data in the form of one or more bits per cell. However, in order to store new updated data, the cells 122 require application of an erasure operation to remove the accumulated charge from the associated floating gates. Accordingly, groups of the flash memory cells 122 may be arranged into erasure blocks, which represent a smallest number of cells that can be erased as a unit.

FIG. 3 illustrates a rewritable memory 130 made up of an array of rewritable memory cells 132. Each memory cell 132 includes a resistive sense element (RSE) 134 in series with a switching device (MOSFET) 136. Each RSE 134 is a programmable memory element that exhibits different programmed data states in relation to a programmed electrical resistance. The rewritable memory cells 132 can take any number of suitable forms, such as RRAM, STRAM, PCRAM, etc.

As noted above, rewritable memory cells such as the cells 134 in FIG. 3 can accept new, updated data without necessarily requiring an erasure operation to reset the cells to a known state. The various cells 132 are interconnected via bit lines (BL) 138, source lines (SL) 140 and word lines (WL) 142. Other arrangements are envisioned, including cross-point arrays that interconnect only two control lines (e.g., a bit line and a source line) to each memory cell.

FIG. 4 illustrates a selected memory tier 150 useful in the multi-tier memory structure 104 of FIG. 1. The memory tier 150 is arranged to provide storage spaces 152, 154 and 156 for data objects, ECC data and metadata, respectively. This is merely exemplary and not limiting as individual tiers may be wholly dedicated to the storage of one type of data (e.g., data objects), or may be dedicated to the storage of just two of these three different types of data sets.

The actual amount of space in a given memory tier for these different types of data sets may also vary widely; for example, a certain memory tier may be arranged so that 90% is dedicated to the storage of data objects and 10% to metadata. As explained below, the ECC data and the metadata in a given memory tier (e.g., the data in memory spaces 154, 156 in FIG. 4) may not necessarily be related to the data objects in that tier (e.g., the data sets in memory space 152 in FIG. 4).

It will be appreciated that increasing the overall available storage space for data objects within the memory structure 104, as well as increasing the available space for data objects in higher tiers with higher levels of I/O data transfer rate performance (e.g., units of data transferred per unit of time), may tend to improve overall performance responsiveness levels at the requestor level. Ultimately, a general goal of data write and read operations is to transfer user data from and to the requestor in an efficient manner.

FIG. 6 illustrates an example format for a data structure 160 made up of a data object 162, ECC data (or ECC data set) 164 and metadata (or a metadata unit) 166. In many cases, the data object 162 will be significantly larger than the corresponding ECC data 164 and metadata unit 166, such as ECC data and metadata units that are around 10% or less in size (in terms of total bits) as compared to the corresponding data object. Nevertheless, the individual sizes of the data objects, ECC data sets and metadata units will depend on the number of data blocks (LBAs) in the data objects, the level of ECC applied and the granularity of the metadata. As used herein, lower metadata granularity implies greater (finer) description of the user data and so a lower granularity may tend to result in a larger metadata unit size.

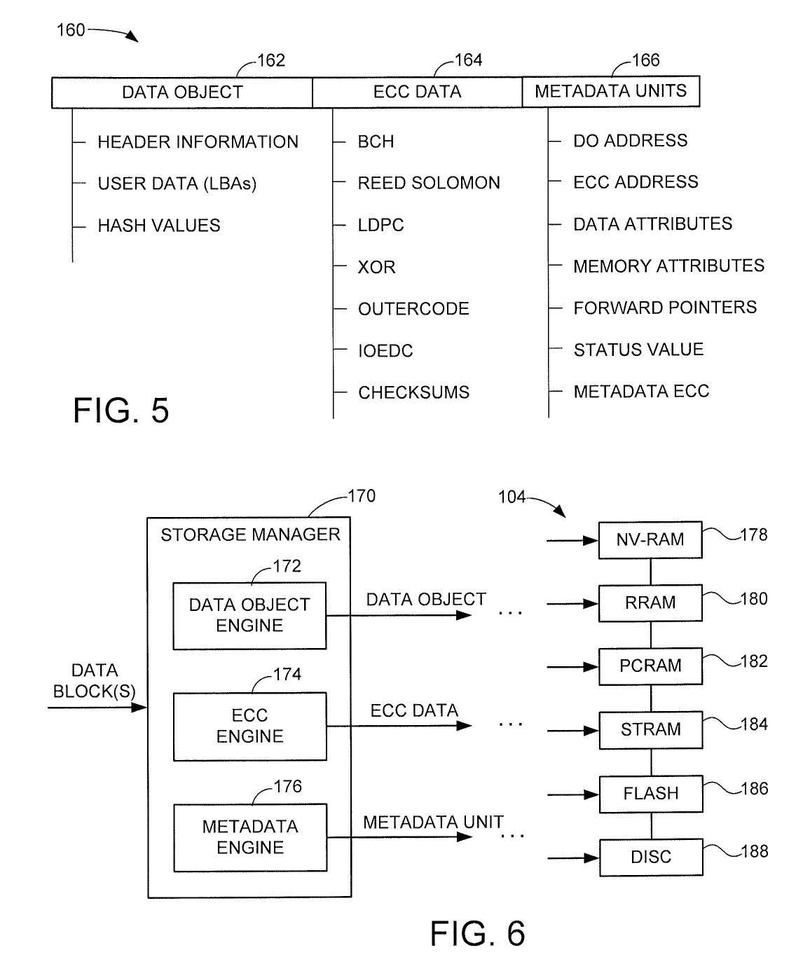

Exemplary content of the various data sets 162, 164 and 166 are set forth in FIG. 5. Other forms and arrangements of content can be provided. The data object 162 is managed as an addressable unit and is formed from one or more data blocks supplied by the requestor (host). The data object can accordingly include header information, user data and other control information such as hash values.

The header information provides suitable identifier information such as a logical address (e.g., an LBA value or range of LBAs) associated with the user data blocks stored in the data object. Other data such as time/date stamp information and status information may be incorporated into the header. The hash value(s) may be formed from the user data blocks using a suitable hash function, such as a Sha hash, for fast reject processing of write amplification. For example, the hash value(s) can be compared to one or more hash values for a newer version of the same LBA or range of LBAs during a write operation. If the hash values match, the newer version may not need to be stored to the memory structure 104 as this may represent a duplicate set of the same user data.

The ECC data 164 can take a variety of suitable forms such as cyclical error correcting codes such as Bose, Ray-Chaudhuri and Hocquenghem (BCH) codes or Reed Solomon codes, low density parity check (LDPC) codes, exclusive-or (XOR) values, outercode, IOEDC values, checksums, and other forms of control data that can be computed to detect and/or correct up to selected numbers of bit errors in the data object 162. More than one type of ECC code data may be generated as the ECC data set for a selected data object.

The size and strength of the ECC data can be selected and subsequently adjusted based on attributes of the data object as well as on attributes of the memory tier in which the ECC data are stored (e.g., number of writes/erasures/reads, aging, drift parametrics, etc.). Generally, the size of an ECC code word generally determines the size of the ECC storage footprint (coderate). Similarly, the sub-code word granularity may be selected in view of the likelihood of read-modify-write operations upon the ECC during operation.

The strength of the ECC data set generally relates to how effective the ECC data set is in detecting and, as utilized, correcting up to a selected number of data bit errors. A stronger ECC data set will generally detect and correct more errors than a weaker ECC data set.

Layered ECC can be used to strengthen ECC protection. A first type of code, such as BCH, can be applied to a data object. A second type of code, such as Reed Solomon, can then be applied to some or all of the BCH code words. Other layers can be applied to achieve an overall desired strength. It will be noted that the strength of the ECC may be selected based on the storage characteristics of the associated data; a memory tier that demonstrates strong performance (high endurance, good retention characteristics, low data bit errors, etc.) may warrant the use of a relatively weaker ECC scheme. Conversely, older, worn and or relatively low endurance memory may warrant the use of stronger ECC. Since in the present embodiments the ECC is stored separately from the data objects, flexibility is provided to allow the appropriate level of ECC to be applied without the constraint of keeping the ECC in the same tier as the protected data objects.

The metadata unit 166 enables the device 100 to locate the data objects and ECC data and accordingly stores a variety of control information such as data object (DO) address information, ECC address information, data and memory attribute information, one or more forward pointers and a status value. Other metadata formats can be used. The address information 174 identifies the physical addresses of the data object 162 and the ECC data 164, respectively, and may provide logical to physical address conversion information as well. The physical address will include which tier (e.g., MEM 1-3 in FIG. 1) stores the data set, as well as the physical location within the associated tier at which the data set is stored using appropriate address identifiers such as row (cache line), die, array, plane, erasure block, page, bit offset, and/or other address values.

The data attribute information identifies attributes associated with the data object such as status, revision level, timestamp data, workload indicators, etc. The memory attribute information constitutes parametric attributes associated with the physical location at which the data object and/or the ECC data are stored. Examples include total number of writes/erasures, total number of reads, estimated or measured wear effects, charge or resistance drift parameters, bit error rate (BER) measurements, aging, etc. These respective sets of attributes can be maintained by the controller and/or updated based on previous metadata entries.

The forward pointers can be used to enable searching for the most current version of a data set (e.g., a data object and/or ECC data) by referencing other copies of metadata in the memory structure 104. The status value(s) indicate the current status of the associated data set (e.g., stale, valid, etc.). As desired, relatively small metadata ECC values can be generated and appended to the metadata unit for verification of the metadata during readback.

FIG. 6 depicts a storage manager 170 of the device 100 operable in accordance with some embodiments. The storage manager 170 may be formed as a portion of the controller functionality. The storage manager 170 is shown to include a number of operational modules including a data object engine 172, an ECC engine 174 and a metadata engine 176. Each of these respective engines generate data objects, ECC data and metadata units in response to data blocks (LBAs) supplied by a requestor.

The multi-tier memory structure 104 of FIG. 1 is shown in FIG. 6 to include a number of exemplary tiers including an NV-RAM module 178, an RRAM module 180, a PCRAM module 182, an STRAM module 184, a flash module 186 and a disc module 188. These are merely exemplary as any number of different types and arrangements of memory modules can be used in various tiers as desired.

The NV-RAM 178 comprises volatile SRAM or DRAM with a dedicated battery backup or other mechanism to maintain the stored data in a non-volatile state. The RRAM 180 comprises an array of resistive sense memory cells that store data in relation to different programmed electrical resistance levels responsive to the migration of ions across an interface. The PCRAM 182 comprises an array of phase change resistive sense memory cells that exhibit different programmed resistances based on changes in phase of a material between crystalline (low resistance) and amorphous (high resistance).

The STRAM 184 comprises an array of resistive sense memory cells each having at least one magnetic tunneling junction made up of a reference layer of material with a fixed magnetic orientation and a free layer having a variable magnetic orientation. The effective electrical resistance, and hence, the programmed state, of each MTJ can be established in relation to the programmed magnetic orientation of the free layer.

The flash memory 186 comprises an array of flash memory cells which store data in relation to an amount of accumulated charge on a floating gate structure. Unlike the NV-RAM, RRAM, PCRAM and STRAM, which are all contemplated as comprising rewriteable non-volatile memory cells, the flash memory cells are erasable so that an erasure operation is generally required before new data may be written. The flash memory cells can be configured as single level cells (SLCs) or multi-level cells (MLCs) so that each memory cell stores a single bit (in the case of an SLC) or multiple bits (in the case of an MLC). The memory cells in the rewritable memory tiers can also be configured as MLCs as desired.

The disc memory 188 may be magnetic rotatable media such as a hard disc drive (HDD) or similar storage device. Other sequences, combinations and numbers of tiers can be utilized as desired, including other forms of solid-state and/or disc memory, remote server memory, volatile and non-volatile buffer layers, processor caches, intermediate caches, etc.

It is contemplated that each tier will have its own associated memory storage attributes (e.g., capacity, data unit size, I/O data transfer rates, endurance, etc.). The highest order tier (e.g., the NV-RAM 178) will tend to have the fastest I/O data transfer rate performance (or other suitable performance metric) and the lowest order tier (e.g., the disc 188) will tend to have the slowest performance. Each of the remaining tiers will have intermediate performance characteristics in a roughly sequential fashion. At least some of the tiers may have data cells arranged in the form of garbage collection units (GCUs) which are allocated from an allocation pool, used to store data, and periodically reset during a garbage collection operation before being returned to the allocation pool for subsequent reallocation.

The respective data object, ECC data and metadata generated by the storage manager 170 in FIG. 6 are contemplated as being stored in different memory tiers 178-188. In one example, the data object is stored in the flash memory 186, the ECC data for the data object is stored in the RRAM module 180 and the metadata are stored in the PCRAM module 182. A suitable tier will be selected for each data set, and the data sets may be subsequently migrated to different tiers based on observed usage patterns and measured memory parametrics.

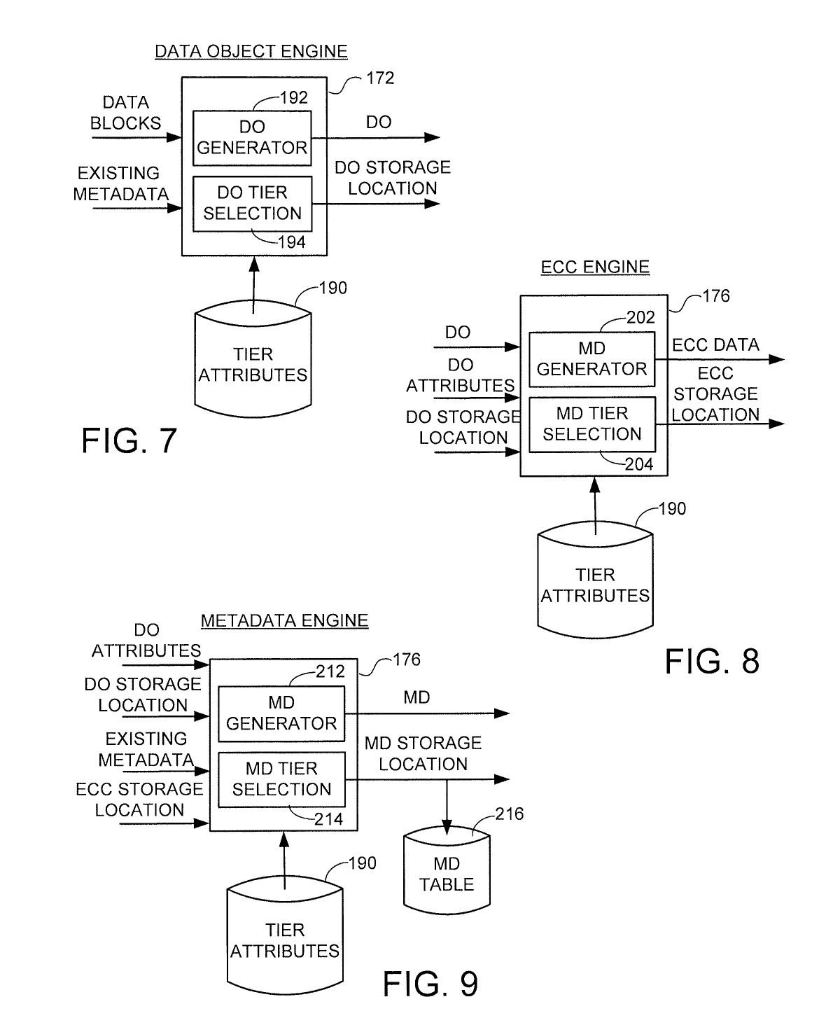

FIG. 7 depicts the data object engine 172 from FIG. 6 in accordance with some embodiments. The data object engine 172 receives the data block(s) (LBAs) from the requestor as well as existing metadata (MD) stored in the device 100 associated with prior version(s) of the data blocks, if such have been previously stored to the memory structure 104. Memory tier attribute data maintained in a database 190 may be utilized by the engine 172 as well.

The engine 172 analyzes the data block(s) to determine a suitable format and location for the data object. The data object is generated by a DO generator 192 using the content of the data block(s) as well as various data-related attributes associated with the data object. A tier selection module 194 selects the appropriate memory tier of the memory structure 104 in which to store the generated data object.

The arrangement of the data object, including overall data object size, may be matched to the selected memory tier; for example, page level data sets may be used for storage to the flash memory 186 and LBA sized data sets may be used for the RRAM, PCRAM and STRAM memories 180, 182, 184. Other unit sizes can be used. The unit size of the data object may or may not correspond to the unit size utilized at the requestor level; for example, the requestor may transfer blocks of user data of nominally 512 bytes in size. The data objects may have this same user data capacity, or may have some larger or smaller amounts of user data, including amounts that are non-integer multiples of the requestor block size.

The DO storage location identified by the DO tier selection module 194 is provided as an input to the memory module 104 to direct the storage of the data object (DO) at the indicated physical address in the selected memory tier. The data object and DO storage location information are also forwarded to the ECC and metadata engines 174, 176.

In FIG. 8, the ECC engine 174 is shown to include an ECC generator 202 and an ECC tier selection module 204. The ECC engine 174 uses the data object, the physical location of the data object (e.g., tier and physical address therein), various data object related attributes, and the memory tier attribute data to generate an appropriate size, strength and level of ECC data for the data object as well as an appropriate memory tier in which to store the ECC data.

The metadata engine 176 from FIG. 7 is shown in FIG. 9 to include a metadata (MD) generator 212 and an MD tier selection module 214. The MD engine 176 uses a number of inputs such as the DO attributes, the DO storage location, the ECC storage location, the existing MD (if available) and memory tier information from the database 190 to select a format, granularity and storage location for the metadata unit 166. In some cases, multiple data objects and/or ECC data sets may be grouped together and described by a single metadata unit.

A top level MD data structure such as MD table 216, which may be maintained in a separate memory location or distributed through the memory structure 104, may be updated to reflect the physical location of the metadata for future reference. The MD data structure 216 may be in the form of a lookup table that correlates logical addresses (e.g., LBAs) to the associated metadata units.

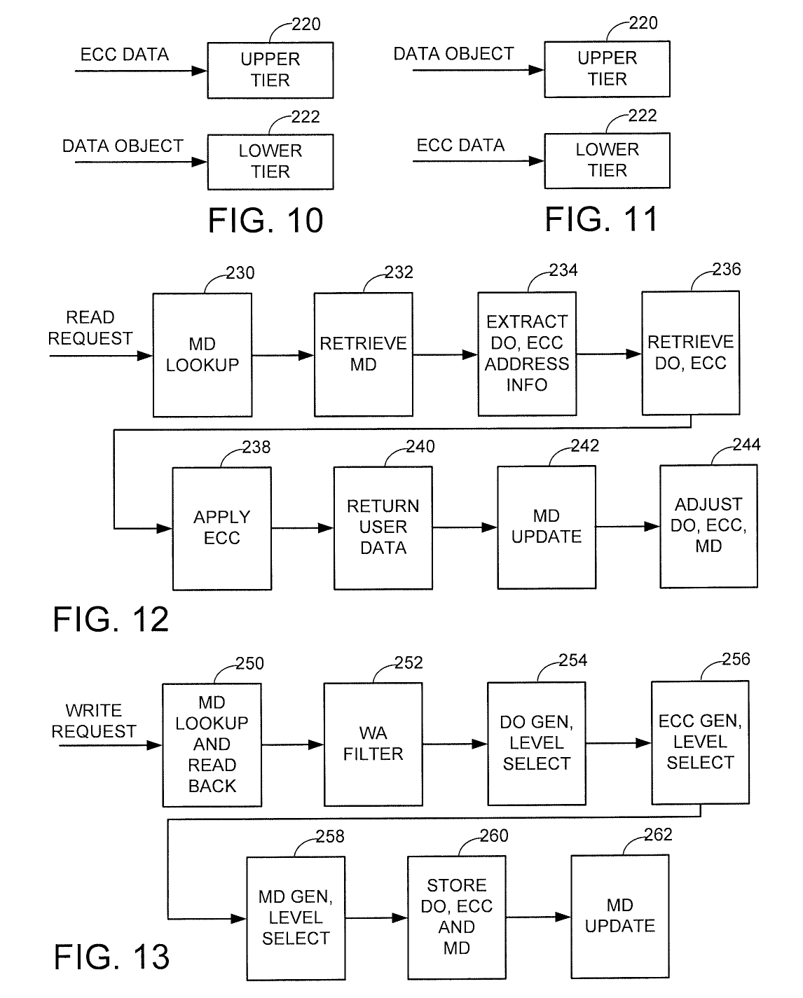

Because the ECC data may tend to be a relatively small fraction of the size of the data objects, higher tiers in the memory structure 104 may be suitable locations for the storage of the ECC data, particularly in relatively high write intensity environments where the ECC are repetitively recovered and updated. FIG. 10 illustrates the storage of ECC data in an upper memory tier 220 in the memory structure 104, and the storage of a corresponding data object to a relatively lower memory tier 222 in the memory structure under these conditions. It will be appreciated that the respective upper and lower tiers 220, 222 can correspond to any of the respective example tiers in FIG. 6, or other memory tiers, so long as the lower tier 222 is lower in the priority ordering of the memory structure 104 as compared to the upper tier 220.

Conversely, as depicted in FIG. 11, because of the relatively smaller ECC footprint it may be desirable to store the data object in the upper tier 220 and to store the ECC data to the lower tier 222. Storing the ECC data at a lower tier in the memory structure 104 as compared to the corresponding data object can facilitate rate matching between data object writes and ECC writes.

For example, if the ECC data is about 10% the size of the data object, and the lower tier 222 is about 10 times (10×) slower than the upper tier 220 (e.g., the lower tier 222 has a data I/O transfer rate that is about 10% the data transfer rate of the upper tier 220), writing the ECC to the lower tier 222 in parallel with the writing of the data object to the upper tier 220 may be faster than writing both data sets to the upper tier 220. This is because it will tend to take about the same amount of time to write the ECC data to the lower tier 222 as it does to write the data object to the upper tier 220, and both can be presumably written during the same write interval.

Storing the ECC in the slower, lower tier 222 does not impart any significant latency during read back processing since the ECC can be substantially recovered from the lower tier 222 during the time required to read back the data object from the faster upper tier 220. Also, storing the ECC in the slower, lower tier 222 frees up that space in the upper tier 220 for the storage of additional data object sets.

The use of tiered ECC as disclosed herein (e.g., storing the ECC in a different tier from the associated data object) allows the size of the ECC data set to be significantly increased for efficiency since a larger codeword provides a more efficient use of ECC algorithms. Any write amplification that arises whenever a subset of the ECC is updated can be acceptable because the ECC may be located in a memory with greater endurance than the memory that stores the corresponding data object. Providing tiered ECC also facilitates the generation of different ECC directions, such as across multiple flash memory pages. The size and strength of the utilized ECC codeword can be adjusted dynamically based on the storage and workload attributes of the memory and data. Of course, writing the ECC data to rewritable memory tiers allows update in place operations, so that an updated version of the ECC data can be written directly onto a prior version of the ECC data thereby replacing the prior version.

Another benefit of tiered ECC is that, as discussed above, an entire tier of memory can be dedicated to the storage of data objects, thereby facilitating the storage of data in locations most suitable for the attributes of the data. Alternatively, a given tier can have dedicated spaces for data objects and ECC data (and metadata as well), with the ECC data (and metadata) describing data objects in a different tier. This allows the storage manager to dynamically select the best utilization of the memory tier as a data storage tier, an ECC storage tier, a data+ECC storage tier, etc. As a given tier wears over time and exhibits degraded performance, the percentage of the memory tier allocated to ECC can increase (and greater levels of ECC can be applied for data stored in that tier). Dynamic allocation based on storage and memory attributes also allows localized workload levels to be adaptively achieved, improving cache hits and other efficient data transfers.

In some cases, the various data sets (data objects, ECC data sets and metadata units) can be respectively stored in the same or different relatively higher tiers, and over time the current version (valid) data sets can be sequentially migrated to lower tiers. By definition, if over time a given portion of memory (such as a garbage collection unit) has both stale (older version) and valid (current version) data, the valid data will tend to be “oldest” data in terms of having been updated the longest. Demoting the valid data sets during garbage collection processing to a lower tier can accordingly allow each type of data to achieve its own appropriate level within the memory structure.

Data access operations can thereafter be carried out upon the data objects, ECC data and metadata units stored to the memory structure 104 in accordance with the foregoing discussion. FIG. 12 represents various steps that can be carried out during a read operation to return previously stored user data to a requestor.

During the read operation, a read request for a selected LBA, or range of LBAs, is received and serviced by locating the metadata associated with the selected LBA(s) through access to the MD data structure 190 or other data structure, block 230. The physical location at which the metadata unit is stored is identified and a read operation is carried out to retrieve the metadata unit to a local memory at block 232. The local memory may be a volatile buffer memory of the device 100.

At block 234, the physical address of the data object and the physical address of the ECC data are extracted from the metadata, and these addresses are used at block 236 to carry out respective read operations to return copies of the data object and ECC data to the local memory. As discussed above, these read operations may be carried out in parallel from two different memory tiers.

The ECC data are applied to the relevant portions of the recovered data object to detect and/or correct bit errors at block 238. Other decoding steps, such as decryption, etc., may be applied at this time as well. Error-free user data blocks are thereafter returned to the requestor at block 240, and the metadata unit may be updated to reflect an increase in the read count for the associated data object. Other parametrics relating to the memory may be recorded as well to the memory tier data structure, such as observed bit error rate (BER), incremented read counts, measured drift parametrics, etc. It is contemplated, although not necessarily required, that the new updated metadata unit will be maintained in the same memory tier as before.

In the case of rewriteable memory tiers the new updates to the metadata (e.g., incremented read count, state information, etc.) may be overwritten onto the existing metadata for the associated data object. For metadata stored to an erasable memory tier (e.g., flash memory 216), the metadata unit (or a portion thereof) may require writing to a new location in the tier.

Finally, based on the read operation, adjustments in the format and/or memory tier for any one, some or all of the data object, ECC data and/or the metadata unit are carried out as warranted, block 244. For example, based on attributes such as a relatively high observed bit err rate (BER), detected drift in parametrics associated with the stored data object, read counts, aging, etc., the storage manager 170 (FIG. 7) may proceed to increase the ECC data level; for example, an LDPC value may be augmented or replaced by a Reed Solomon Code to provide stronger ECC capabilities during a subsequent read operation upon the data. In one embodiment, the ECC strength is automatically incremented to a next higher level if a selected number of read bit errors are detected during the read back of the data object.

The updated ECC data may be stored in the same memory tier as before, or a new tier may be selected. If a new tier is selected, the associated metadata unit will be updated to reflect the new location for the ECC data. Other adjustments can be made as well. It will be noted that background processing can be enacted at the conclusion of each read operation (or each read operation exhibiting parameters that fall outside predetermined thresholds) to evaluate the continued suitability of the existing memory tiers and formats for the data object, ECC data and metadata. Additionally and/or alternatively, periodic analyses during idle times can be enacted to evaluate existing parametric settings and make such adjustments.

It is noted that a given metadata unit may be distributed across the different tiers so that portions requiring frequent updates are stored in one tier that can easily accommodate frequent updates (such as a rewriteable tier and/or a tier with greater endurance) and more stable portions of the metadata that are less frequently updated can be maintained in a different tier (such as an eraseable tier and/or a tier with lower endurance). Similarly, the ECC data may be distributed across the different tiers to provide different levels of ECC protection for the data sets.

FIG. 13 depicts write operation processing that may be carried out in accordance with some embodiments. During the writing of new data to the memory structure 104, a write command and an associated set of user data are provided from the requestor to the device 100, resulting in an initial metadata lookup operation to locate a previously stored most current version of the data, if such exists, block 250. If so, the metadata are retrieved and a preliminary write amplification filtering analysis may take place at block 252 to ensure the newly presented data represent a different version of data.

At block 254, a data object is generated and an appropriate memory tier level for the data object is selected. As discussed above, various data and memory related attributes may be used to select the appropriate memory tier, and then a next available memory location within that tier may be allocated for the transfer of the data object. Similar operations are carried out at blocks 256 and 258 to generate appropriate ECC data and metadata units for corresponding tiers based on the various factors discussed above. The respective data object, ECC data and metadata unit are thereafter stored to different tiers at block 260. In some cases, the transfers may be carried out in parallel during the same overall time interval.

It will be noted that in the case where a previous version of the data object, ECC data and metadata are resident in the memory structure 104, the new versions of these data sets may, or may not, be stored in the same respective memory tiers as the previous versions. Older version data sets may be marked as stale and adjusted as required, such as by the addition of one or more forward pointers in the old MD unit to point to the new location. This operation is indicated at block 262.

The metadata granularity is selected based on characteristics of the corresponding data object. As used herein, granularity generally refers to the unit size of user data described by a given metadata unit; the smaller the metadata granularity, the smaller the unit size and vice versa. As the metadata granularity decreases, the size of the metadata unit may increase. This is because the metadata needed to describe 1 megabyte (MB) of user data as a single unit (large granularity) would be significantly smaller than the metadata required to individually describe each 16 bytes (or 512 bytes, etc.) of that same 1 MB of user data (small granularity). The ECC data may be selected to have an appropriate level that corresponds to the granularity of the metadata.

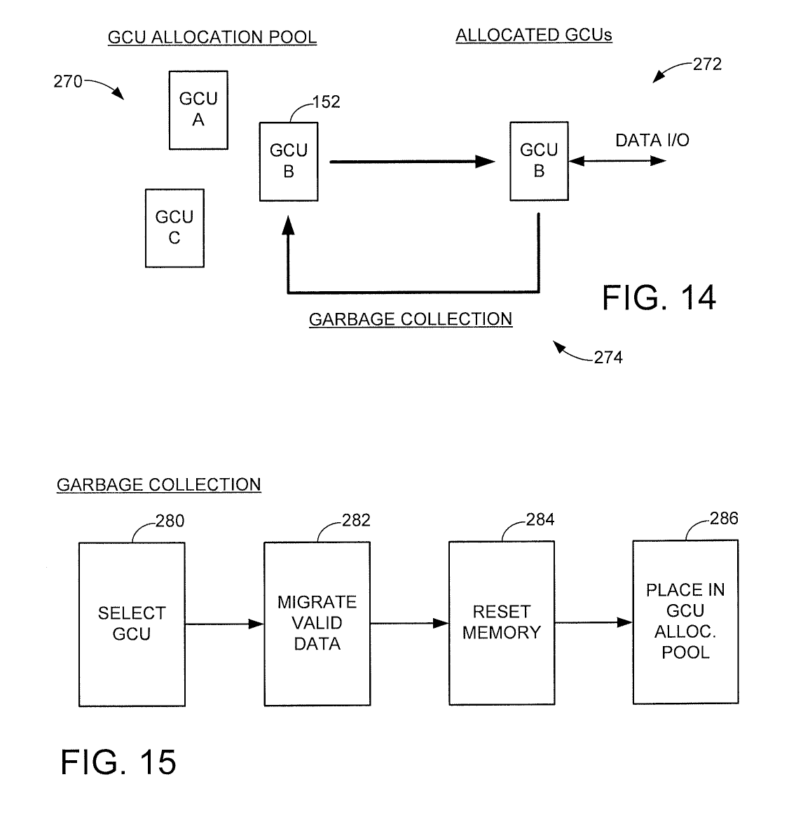

FIG. 14 depicts a garbage collection process that may be carried out in accordance with the foregoing discussion. One, some or all of the various memory tiers in the memory structure 104 (such as the various tiers 178-188 in FIG. 6) may be arranged into garbage collection units (GCUs) which are allocated and reset as a unit.

GCUs are particularly suitable for erasable memories, such as flash memory, that require a separate erasure operation prior to storage of new data in a selected location. GCUs can also be used in rewritable memories to break a larger memory space into smaller, more manageable sections that can be allocated as required, reset and then returned to an available allocation pool. The use of GCUs in both erasable and rewritable memories can enable better tracking of memory history metrics and parameters and can provide improved level loading; that is, GCUs can help ensure that all of the memory cells in a given tier receive substantially the same general amount of usage in writing data, rather than concentrating on one particular area that receives most of the I/O workload.

A GCU allocation pool is denoted at 270 in FIG. 14. This represents a number of available GCUs (denoted in FIG. 14 as GCU A, GCU B and GCU C) that can be selected by the storage manager to accommodate new data sets. Once allocated, the GCU transitions to an operational state 272, during which various data I/O operations are carried out as discussed above. After a selected period of time, the GCU may be subjected to garbage collection processing, as indicated at 274.

Garbage collection processing is generally represented by the flow of FIG. 15. A GCU (such as GCU B) is selected at step 280. The selected GCU may store data objects, ECC data, metadata units or all three of these types of data sets. The storage manager 170 (FIG. 6) examines the state of each of the data sets in the selected GCU to determine which represent valid data and which represent stale data. Stale data sets may be indicated from the metadata or from other data structures as discussed above. It will be appreciated that stale data sets generally represent data sets that do not require continued storage, and so can be jettisoned. Valid data sets should be retained, such as because the data sets represent the most current version of the data, the data sets are required in order to access other data (e.g., metadata units having forward pointers that point to other metadata units, etc.), and so on.

The valid data sets from the selected GCU are migrated at step 282. It is contemplated that in most cases, the valid data sets will be copied to a new location in a lower memory tier in the memory structure 104. Depending on the requirements of a given application, at least some of the valid data sets may be retained in a different GCU in the same memory tier based on data access requirements, etc. It will be appreciated that all of the demoted data may be sent to the same lower tier, or different ones of the demoted data sets may be distributed to different lower tiers.

The memory cells in the selected GCU are next reset at step 284. This operation will depend on the construction of the memory. In a rewritable memory such as the PCRAM tier 182 (FIG. 6), for example, the phase change material in the cells in the GCU may be reset to a lower resistance crystalline state. In an erasable memory such as the flash memory tier 186, an erasure operation may be applied to the flash memory cells to remove substantially all of the accumulated charge from the floating gates of the flash memory cells to reset the cells to an erased state. Once the selected GCU has been reset, the GCU is returned to the GCU allocation pool at step 286 pending subsequent reallocation by the system.

Based on the foregoing discussion, it can be seen that migration of ECC data to a next lower level can be advantageous in moving the data to a lower tier and freeing up the existing tier for the storage of higher priority data. The ECC level of the demoted ECC data may be evaluated and adjusted to a format better suited to the new lower memory tier.

As used herein, “erasable” memory cells and the like will be understood consistent with the foregoing discussion as memory cells that, once written, can be rewritten to less than all available programmed states without an intervening erasure operation, such as in the case of flash memory cells that require an erasure operation to remove accumulated charge from a floating gate structure. The term “rewritable” memory cells and the like will be understood consistent with the foregoing discussion as memory cells that, once written, can be rewritten to all other available programmed states without an intervening reset operation, such as in the case of NV-RAM, RRAM, STRAM and PCRAM cells which can take any initial data state (e.g., logical 0, 1, 01, etc.) and be written to any of the remaining available logical states (e.g., logical 1, 0, 10, 11, 00, etc.).

Numerous characteristics and advantages of various embodiments of the present disclosure have been set forth in the foregoing description, together with structural and functional details. Nevertheless, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A method comprising:
storing a data object in a first non-volatile tier of a multi-tier memory structure;
generating an ECC data set adapted to detect at least one bit error in the data object during a read operation; and
storing the ECC data set in a different, second non-volatile tier of the multi-tier memory structure.

2. The method of claim 1, in which the second non-volatile tier is selected responsive to a data attribute associated with the data object and a storage attribute associated with the second non-volatile tier.

3. The method of claim 1, in which the multi-tier memory structure comprises a plurality of non-volatile memory tiers each having different data transfer attributes and corresponding memory cell constructions arranged in a sequential priority order from highest to lowest.

4. The method of claim 3, in which the first non-volatile tier is a higher tier than the second non-volatile tier in the multi-tier memory structure.

5. The method of claim 3, in which the first non-volatile tier is a lower tier than the second non-volatile tier in the multi-tier memory structure.

6. The method of claim 1, in which the storing step comprises selecting the second non-volatile tier from a plurality of available lower tiers in the multi-tier memory structure responsive to a size of the ECC data set relative to a size of the data object.

7. The method of claim 6, in which the storing step further comprises selecting the second non-volatile tier from said plurality of available lower tiers in the multi-tier memory structure responsive to a data I/O transfer rate of the second non-volatile tier relative to a data I/O transfer rate of the first non-volatile tier.

8. The method of claim 1, in which the data object and the ECC data are stored simultaneously to the respective first and second non-volatile memory tiers over a common elapsed time interval.

9. The method of claim 1, in which the data object comprises at least one user data block supplied by a requestor device for storage in the multi-tiered memory structure, the ECC data comprises a codeword adapted to detect and correct up to at least one bit error in the data block during a read back operation.

10. The method of claim 1, further comprising generating a metadata unit comprising address information identifying a storage location of the data object within the first non-volatile memory tier and a storage location of the ECC data within the second non-volatile memory tier, wherein the metadata unit is stored in a different, third non-volatile tier in the multi-tier memory structure.

11. The method of claim 1, in which a selected one of the first or second tiers comprises rewriteable non-volatile memory cells and a remaining one of the first or second tiers comprises erasable non-volatile memory cells.

12. The method of claim 1, in which the multi-tier memory structure provides a plurality of tiers in sequential order from a fastest tier to a slowest tier, the second tier being slower than the first tier, and in which the method further comprises storing a second data object in the first tier and a corresponding second ECC data set to correct at least one bit error in the second data object in a third tier, the third tier faster than the first tier.

13. The method of claim 1, in which the multi-tier memory structure comprises a plurality of non-volatile memory tiers each having different data storage attributes, and the method further comprises selecting the first and second tiers by matching data storage attributes of the data object and the ECC data set to the respective first and second tiers.

14. An apparatus comprising:
a multi-tier memory structure comprising a plurality of non-volatile memory tiers each having different data transfer attributes and corresponding memory cell constructions, the memory tiers arranged in a priority order from fastest to slowest data I/O data transfer rate capabilities; and
a storage manager adapted to generate a data object responsive to one or more data blocks supplied by a requestor, to generate an ECC data set for detecting up to a selected number of read back bit errors in the data object during a read back operation, to store the data object in a first selected memory tier of the multi-tier memory structure, and to store the ECC data set in a different second selected memory tier of the multi-tier memory structure.

15. The apparatus of claim 14, in which the storage manager selects the second memory tier responsive to a data attribute associated with the data object and a storage attribute associated with the second memory tier.

16. The apparatus of claim 14, in which the first selected memory tier comprises a relatively faster memory and the second selected memory tier comprises a relatively slower memory.

17. The apparatus of claim 14, in which the first selected memory tier comprises a relatively slower memory and the second selected memory tier comprises a relatively faster memory.

18. The apparatus of claim 14, in which a selected one of the first or second memory tiers comprises an erasable non-volatile memory and a remaining one of the first or second memory tiers comprises a rewritable non-volatile memory.

19. The apparatus of claim 14, in which the storage manager selects the second non-volatile tier from a plurality of available lower tiers in the multi-tier memory structure responsive to a size of the ECC data set relative to a size of the data object.

20. The method of claim 1, in which the storage manager further generates a metadata unit comprising address information identifying a storage location of the data object within the first selected memory tier and a storage location of the ECC data within the second selected memory tier, wherein the metadata unit is stored in a different, third selected tier in the multi-tier memory structure.
